(19) United States
(12) Patent Application Publication
(10) Pub. No.: US 2002/0030382 A1
(43) Pub. Date: Mar. 14, 2002

(54) Support rod for a retractable vehicle top

(76) Inventor: Andreas Hasselgruber, Eberdingen-Nussdorf (DE)

Correspondence Address: KLAUS J. BACH & ASSOCIATES, PATENT AND TRADEMARKS, 4407 TWIN OAKS DRIVE, MURRYSVILLE, PA, 15668, US

(21) Appl. No.: 09/990,968

(22) Filed: Nov. 16, 2001

Related U.S. Application Data
(63) Continuation-in-part of application No. PCT/EP01/05065, filed on May 4, 2001.

(30) Foreign Application Priority Data
May 11, 2000 (DE) 100 23 047.4

(51) Int. Cl. B60J 7/12

(52) U.S. Cl. 296/118

(57) ABSTRACT

In a support rod component for a vehicle top, which is movable between closed and open positions, the support rod component includes a support rod center part which is provided, at least at one end thereof, with a reception opening extending axially into the support rod center part and having a cross-section of a joint part portion, which is received in the reception opening and firmly connected to the support rod center part.

This is a Continuation-In-Part application of international patent application PCT/EP01/05065 filed May 4, 2001 and claiming the priority of German application No. 100 23 047.4 filed May 11, 2000.

### BACKGROUND OF THE INVENTION

The invention relates to a support rod for a retractable vehicle top, which is movable between a closed and an open position and which comprises a center part and a joint portion mounted at least at one end of the center part.

DE 943 747 discloses a motor vehicle top which is movable between a closed position and an open position and which consists of a top support rod structure with various rods as well as a top cover material which is supported by the top support rod structure. The support rod structure comprises levers, guide rods, and hoops, which form a cooperating kinematic support linkage structure permitting opening and closing movement of the vehicle top. In the open position, the vehicle top should be compact so as to require only a small storage space. In order to provide for a three dimensional movement of the vehicle top between the closed and the open positions, the support rods and links include joints by which the rods and links are pivotally joined or pivotally connected to the vehicle body. The joints are formed by joint members, which are welded to a center section of the support rods.

It is furthermore known to provide the support rod parts as single piece components made as forged, cast or stamped parts. In those embodiments, the center section of the support rod and the joint portions at the ends are formed as an integral component, wherein however the joint portions at the ends of the rods have to be finished at relatively high expenses in order to provide for the quality and accuracy required for the end joints.

In both, the two-part embodiment with a joint portion welded to the center section of the support rod as well as the single piece embodiment, the support rod must be subjected to extensive and time-consuming finishing work which causes relatively high expenses because of the large number of rod components needed for the support of a retractable vehicle top.

DE 195 32 568 C1 discloses a joint arrangement including an essentially cylindrical housing provided, at one end thereof, with a sleeve into which a stud is axially threaded and forms a support structure for a ball joint arrangement for mounting to a vehicle body. The sleeve is a component, which is separate from the housing and is inserted into the cylindrical housing.

The joint arrangement is connected to the housing by two intermediate components, that is, the stud whose free end carries the ball joint arrangement and the sleeve into which the other end of the stud is threaded. This joint arrangement requires a plurality of individual components, whereby the manufacturing and assembly expenses are relatively high.

It is the object of the present invention to provide linkage parts or support rods with end joints of high quality, which can be manufactured in a simple and inexpensive manner.

### SUMMARY OF THE INVENTION

In a support rod component for a vehicle top, which is movable between closed and open positions, the support rod component includes a center part which is provided with a reception opening extending axially into the support rod center part from one end thereof and having a cross-section corresponding to that of a joint portion which is received in the reception opening and is firmly connected to the support rod center part.

The novel support or linkage rod is a multi-part component and comprises a center part and at last one joint portion, which is disposed at one end of the center part and connected thereto. Such an arrangement has the advantage that the joint portion, which is connected to the center support or linkage rod part, can be a standard component. In this way, particularly the joint portion can be manufactured in a time and cost efficient manner and can be used in connection with center support or linkage rod parts, which are adapted individually to the respective conditions.

The form-fitting engagement between the center support or linkage rod part and the joint part provides for sufficient force transmission capability. The form-fitting engagement between the center part and the joint part is in a direction transverse to the longitudinal axis of the center part so that it is possible to slidingly insert the joint part into the center support rod part and also to remove it therefrom. When the joint part is disposed within the center part, forces can be transmitted in a direction transverse to the longitudinal axis of the center part. Furthermore, the center support or linkage rod parts are also interconnected for example by welding or cementing so that forces can be transmitted also in the longitudinal direction of the center part. Alternatively, or in addition, to the connection by welding or cementing a force- and form-locking connection in the direction of the longitudinal axis of the center part and the joint part may be provided.

The reception opening at the end of the center part can be of a standardized shape adapted to the dimensions of the joint part so that any joint part can be inserted into, and attached to, the end of any center part, providing for the possibility of assembling different support or linkage rods in a simple manner from few parts.

The reception opening is formed in a reception sleeve, which is firmly connected to the center part. The reception sleeve may be an individual component, which is connected to the center part, for example by welding, or it may be formed from the center part, for example by cutting or by non-cutting shaping of the end of the center rod part to provide an opening corresponding to the cross-section of the standardized joint part.

It is advantageous if both ends of the center rod part are prepared for the reception of standardized joint parts. By a particular selection of the joint parts, different joints may be provided at the opposite ends of the center rod part.

At least in the area of the interconnection of the center rod part and the joint parts, they both consist of a weldable material, particularly of a chromium-nickel steel.

With the use of standardized joint parts not only the costs are reduced but also the need for a mechanical finishing of the support rod is eliminated. The joint parts can be manufactured sufficiently accurately already before they are mounted to the center part. Also, a finishing surface treatment of the joint parts is not absolutely necessary.

The insertion of the joint parts into the reception opening in the center support part has furthermore the advantage that the insertion depth in the direction of the longitudinal axis of the center part can be adjusted to respective design conditions.

An embodiment of the invention will be described below on the basis of the accompanying drawings.

### BRIEF DESCRIPTION OF THE DRAWINGS

FIG. 1 is a perspective view of a retractable vehicle top, which is provided with the support rods or linkage components according to the invention,

FIG. 2 is a top view of an end section of a support rod with a center rod part and a joint part connected to the center part,

FIG. 3 is a cross-sectional view taken along line III-III of FIG. 2,

FIG. 4 is a top view of a support rod which includes joint parts at both of its opposite ends, and

FIG. 5 is a cross-sectional view taken along line V-V of FIG. 4.

### DESCRIPTION OF PREFERRED EMBODIMENTS

In the following description, identical components are designated by the same reference numerals.

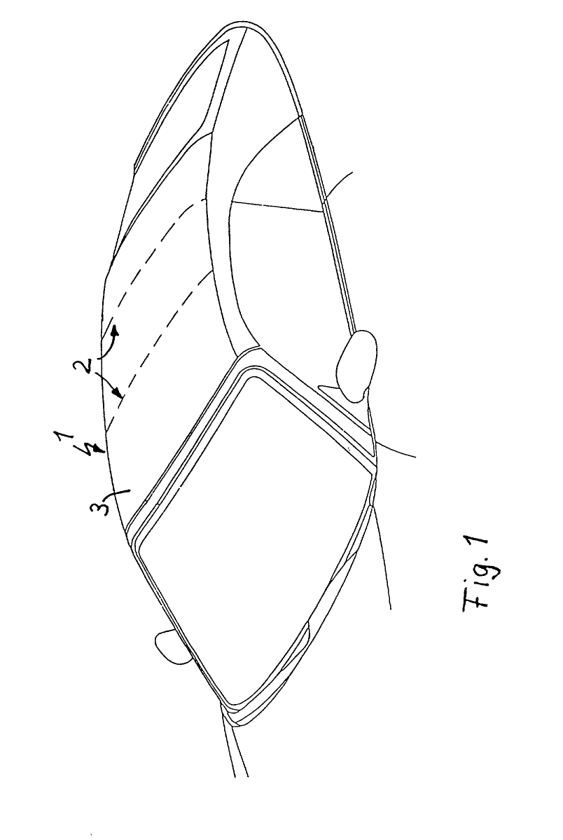

The vehicle top 1 shown in FIG. 1 is movable between a closed position, in which it covers the passenger compartment of a vehicle and an open position, in which the vehicle top is removed so that the passenger compartment is open. The vehicle top consists of a top support rod and linkage arrangement 2 comprising a plurality of rod components 4, which are pivotally interconnected and pivotally connected to the vehicle body and a top cover material 3, which is supported by the support rod and linkage arrangement 2. The vehicle top 1 is shown in the example given as a folding top; however, it may also be in the form of a hard top if desired.

The design of the support rods forming the top support rod arrangement 2 will be described below in greater detail on the basis of the enclosed drawings.

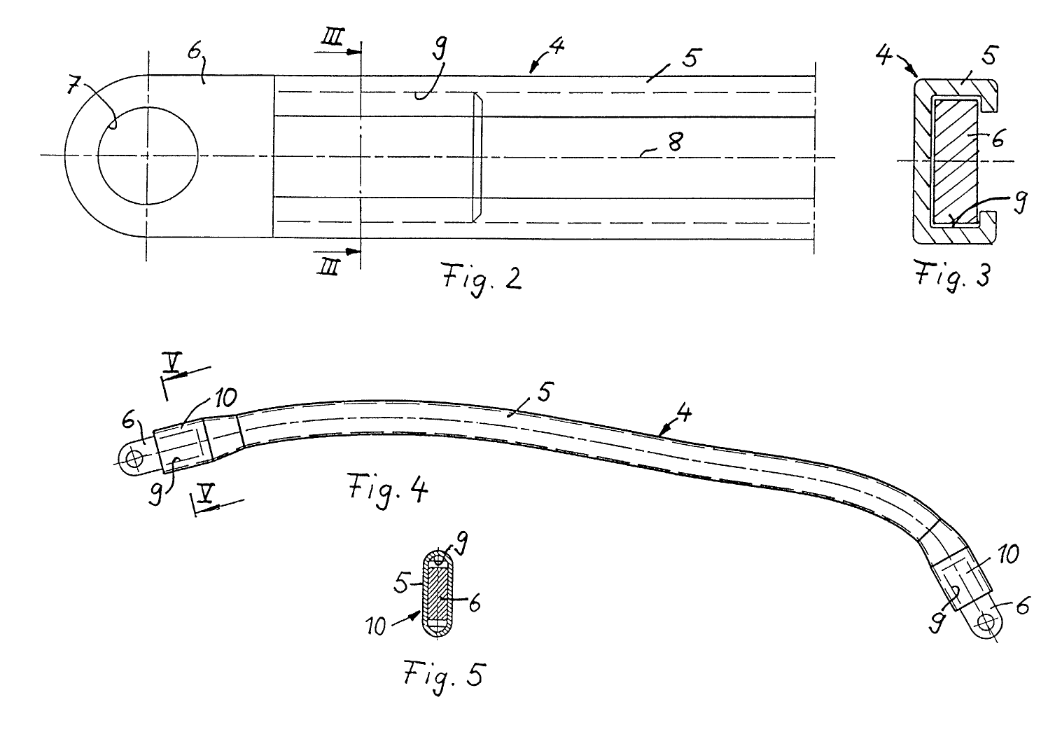

As shown in FIG. 2, the support rod component 4, which is part of the support rod arrangement, consists of a center rod part 5 and a joint part 6 disposed at an end of the center rod part 5. The joint part 6 includes a joint eye 7 for pivotal connection to another rod component or a link or, respectively, the vehicle body. The center rod part 5 and the joint part 6 are formed as separate component which, when assembled, are interconnected so as to be firmly fixed relative to each other in the direction of the longitudinal axis 8 of the center rod part. They may be interconnected in a form-locking or a material-joining manner (welding) such that a force transmission in the direction of the longitudinal axis of the center rod part 5 becomes possible between the two parts. In addition, form-locking between the center rod part 5 and the joint part 6 in a direction transverse to the longitudinal axis 8 is also provided so that large forces transverse to the longitudinal axis 8 can also be transmitted.

For the assembly of the support rod component 4, the center rod part 5 is be provided at its end with a reception opening 9, into which the joint part 6 is axially so far inserted until the desired axial position of the joint part 6 relative to the center support part 5 is achieved. In this position, the joint part 6 is then firmly fixed in the reception opening 9. As can be seen from the sectional view of FIG. 3, the center support rod part 5 is a hollow profiled rod, which is open along one side thereof. The inner shape of the center rod part 5 is adapted, at the axial end thereof, to the shape of the joint part 6 to be received thereby. The joint part 6 to be received in the reception opening 9 has a rectangularly shaped cross-section in the embodiment shown in FIG. 3.

FIGS. 4 and 5 show a modified embodiment of the support rod component 4. In this case, the support rod center part 5 of the support rod component 4 is provided at each of its opposite ends with a mounting sleeve 10 having an axial reception opening 9 for receiving the joint part 6. The mounting sleeve 10 can be formed integrally with the support rod center part 5, that is, it can be formed directly from the support rod center part 5 by appropriate shaping of the ends of the support rod center part 5 or the sleeves 10 may be separate components, which are firmly joined to the ends of the support rod center part 5, for example, by welding. The support sleeve 10 is adapted in the transition area between support rod center part 5 and the sleeve 10 to the shape of the support rod center part 5, but, at its opposite end, its internal shape is adapted to the shape of the joint part 6. In the embodiment, as shown in FIGS. 4 and 5, the support sleeve 10 is flattened providing for a cross-section with two parallel longitudinal side portions which are joined by partial circular opposite narrow side sections. The dimensions of the reception opening 9 in the support sleeve 10 and of the joint part 6 are so adapted to each other that the thickness of the joint part 6 corresponds to the width of the reception opening 9, and the joint part 6 is engaged in the reception opening 9 without play.

Advantageously, the joint part 6 and the support rod center part 5 consist at least in their adjoining areas of a nickel-chromium steel. Preferably, they consist completely of nickel-chromium steel.

What is claimed is:

1. A support rod component for a vehicle top which is movable between closed and open positions, said support rod component comprising a support rod center part having, at least at one end thereof, a reception opening extending axially into said support rod center part and having a predetermined cross-section, and a joint part having a portion with a cross-section corresponding to the cross-section of said reception opening in said support rod center part and being inserted into said reception opening to a desired axial position, in which said joint part is firmly connected to said support rod center part, said joint part portion and said support rod center part being engaged in a form-locking fashion in a direction transverse to the longitudinal axis of said support rod center part.

2. A support rod component according to claim 1, wherein said support rod center part is provided at both ends with reception openings which are both of the same shape for receiving joint parts having the same joint part portions.

3. A support rod component according to claim 2, wherein the ends of said support center parts are flattened and the reception openings in the ends of said support rod center part have oblong cross-sections.

4. A support rod component according to claim 1, wherein said joint part is connected to said support rod center part by joining the materials of which said support rod center part and said joint part consist (welding).

5. A support rod component according to claim 1, wherein said joint part consists of nickel-chromium steel.

6. A support rod component according to claim 1, wherein said support rod center part consists at least on the area in which it is joined with said joint part, of nickel-chromium steel.
